(19) United States
(12) Patent Application Publication
(10) Pub. No.: US 2026/0342780 A1
(43) Pub. Date: Oct. 29, 2026

(54) INFORMATION PROCESSING APPARATUS, INFORMATION PROCESSING METHOD, AND NON-TRANSITORY COMPUTER-READABLE RECORDING MEDIUM

(71) Applicant: NEC Corporation, Tokyo (JP)

(72) Inventors: Atsushi NAGATA, Tokyo (JP); Toru TOMITA, Tokyo (JP)

(73) Assignee: NEC Corporation, Tokyo (JP)

(21) Appl. No.: 19/645,516

(22) Filed: Apr. 13, 2026

(30) Foreign Application Priority Data
Apr. 25, 2025 (JP) 2025-073165

(51) Int. Cl. H04L 9/40

(52) U.S. Cl. CPC H04L 63/08

(57) ABSTRACT

According to an aspect of the present disclosure, an information processing apparatus detects a failure of authentication of a client device in a case where communication between the client device and a server apparatus as an access destination is established by authentication, generates, in a case where the failure of authentication has been detected, a changed domain that is a domain associated with an IP address of the access destination and is a domain of the access destination different from a domain at time of the failure of authentication, and requests the client device to perform redirection by a URL using the changed domain.

This application is based upon and claims the benefit of priority from Japanese Patent Application No. 2025-073165, filed on Apr. 25, 2025, the disclosure of which is incorporated herein in its entirety by reference.

### TECHNICAL FIELD

The present disclosure relates to an information processing apparatus, an information processing method, and a program.

### BACKGROUND ART

Authentication may be performed when communication between a client device and a server apparatus is established. As an example, there is Mutual Transport Layer Security (mTLS). mTLS is a mechanism in which a client device and a server apparatus mutually perform authentication using a certificate, and thus communication between the client device and the server apparatus is established.
JP 2024-167271 A discloses a technique using mTLS in order to access a service supported by a tenant of a multi-tenant system.

### SUMMARY

According to an aspect of the present disclosure, an information processing apparatus includes detection unit that detect a failure of authentication of a client device in a case where communication between the client device and a server apparatus as an access destination is established by authentication, generation unit that generate, in a case where the failure of authentication has been detected, a changed domain that is a domain associated with an IP address of the access destination and is a domain of the access destination different from a domain at time of the failure of authentication, and control unit that request the client device to perform redirection by a URL using the changed domain.

According to another aspect of the present disclosure, an information processing method includes detecting a failure of authentication of a client device in a case where communication between the client device and a server apparatus as an access destination is established by authentication, generating, in a case where the failure of authentication has been detected, a changed domain that is a domain associated with an IP address of the access destination and is a domain of the access destination different from a domain at time of the failure of authentication, and requesting the client device to perform redirection by a URL using the changed domain.

According to still another aspect of the present disclosure, a non-transitory computer-readable recording medium storing a program causes a computer to execute a process including detecting a failure of authentication of a client device in a case where communication between the client device and a server apparatus as an access destination is established by authentication, generating, in a case where the failure of authentication has been detected, a changed domain that is a domain associated with an IP address of the access destination and is a domain of the access destination different from a domain at time of the failure of authentication, and requesting the client device to perform redirection by a URL using the changed domain.

### BRIEF DESCRIPTION OF THE DRAWINGS

FIG. 1 is a first block diagram illustrating an example of a functional configuration of an information processing apparatus according to the present disclosure;

FIG. 2 is a first flowchart illustrating an example of an operation of the information processing apparatus according to the present disclosure;

FIG. 3 is a first diagram schematically illustrating an example of a configuration including the information processing apparatus according to the present disclosure;

FIG. 4 is a sequence diagram illustrating an example of establishment of communication by mTLS according to the present disclosure;

FIG. 5 is a second block diagram illustrating an example of a functional configuration of an information processing apparatus according to the present disclosure;

FIG. 6 is a diagram illustrating an example of a DNS record according to the present disclosure;

FIG. 7 is a first diagram illustrating an example of output information according to the present disclosure;

FIG. 8 is a second diagram illustrating the example of the output information according to the present disclosure;

FIG. 9 is a second flowchart illustrating an example of an operation of the information processing apparatus according to the present disclosure;

FIG. 10 is a second diagram schematically illustrating an example of a configuration including the information processing apparatus according to the present disclosure; and

FIG. 11 is a block diagram illustrating an example of a hardware configuration of a computer apparatus that implements the information processing apparatus according to the present disclosure.

### EXAMPLE EMBODIMENT

Hereinafter, example embodiments of the present disclosure will be described with reference to the drawings.

### First Example Embodiment

An outline of an information processing apparatus according to a first example embodiment will be described.

First, an example of a situation to which the information processing apparatus according to the present disclosure is applied will be described. A client device accesses a server apparatus by using a browser. At this time, authentication processing using a certificate is performed. When the client device and the server apparatus are successfully authenticated, communication between the client device and the server apparatus is established. On the other hand, when at least one of the client device and the server apparatus fails in authentication, communication is not established. An example of the information processing apparatus according to the present disclosure is an apparatus that enables the server apparatus to perform authentication processing of the client device again in a case where the server apparatus has failed in authentication of the client device in a situation where such communication has been attempted.

An example of the information processing apparatus is the above-described server apparatus. The present disclosure is not limited to this example, and the information processing apparatus may be an apparatus included in a server apparatus. Alternatively, the information processing apparatus may be an apparatus different from the server apparatus as an access destination of the client device. In this case, the information processing apparatus is communicably connected to the server apparatus. In the present disclosure, an example in which the information processing apparatus is a server apparatus as an access destination of a client device will be mainly described.

The client device is a device including an input/output device used by a user. For example, the client device includes an input device such as a keyboard and a touch panel. The client device includes an output device such as a display. The client device is, for example, a personal computer, but is not limited to this. The client device may be a mobile terminal such as a smartphone and a tablet terminal. The client device can communicate with the information processing apparatus via a wired or wireless network.

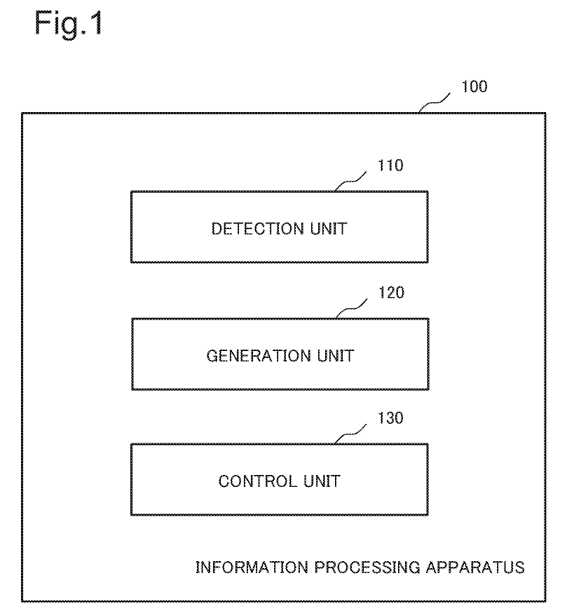

FIG. 1 is a first block diagram illustrating an example of a functional configuration of an information processing apparatus 100. As illustrated in FIG. 1, the information processing apparatus 100 includes a detection unit 110, a generation unit 120, and a control unit 130.

The detection unit 110 detects failure of authentication of the client device. The failure of authentication means a failure of verification of a certificate. For example, a client certificate is transmitted from a client device to a server apparatus as an access destination. The server apparatus verifies the client certificate. In such a case, the detection unit 110 may detect that the verification has failed, as the failure of the authentication.

As described above, in a case where communication between the client device and the server apparatus as the access destination is established by authentication, the detection unit 110 detects failure of authentication of the client device. The detection unit 110 is an example of detection means.

In a case where the failure of the authentication has been detected, the generation unit 120 generates a domain different from the used domain. The domain is associated with an Internet Protocol (IP) address. For example, a user of the client device attempts to access a server apparatus by using a domain as the access destination. The client device accesses a server apparatus designated by the IP address associated with the domain, and authentication processing is performed.

The generation unit 120 generates a domain different from the domain used for access and associated with the same IP address as an IP address of the access destination. In other words, the generation unit 120 generates a domain that is associated with the same IP address and is different from a domain at time of the failure of the authentication. Here, the generated domain is also referred to as a “changed domain”. The access destination of the client device is also simply referred to as an “access destination”. That is, the domain at the time of the failure of authentication and the changed domain have different character strings, and have the same access destinations.

As described above, in a case where the failure of the authentication has been detected, the generation unit 120 generates the changed domain that is a domain associated with the IP address of the access destination and is a domain of the access destination different from that at the time of the failure of the authentication. The generation unit 120 is an example of generation means.

The control unit 130 requests redirection from the client device. For example, in a case where the server apparatus has failed in authentication of the client device, the control unit 130 requests the client device to perform redirection to a uniform resource locator (URL) including the changed domain. As a result, the client device can access the server apparatus by using the URL including the changed domain.

As described above, the control unit 130 requests the client device to perform redirection with the URL using the changed domain. The control unit 130 is an example of control means.

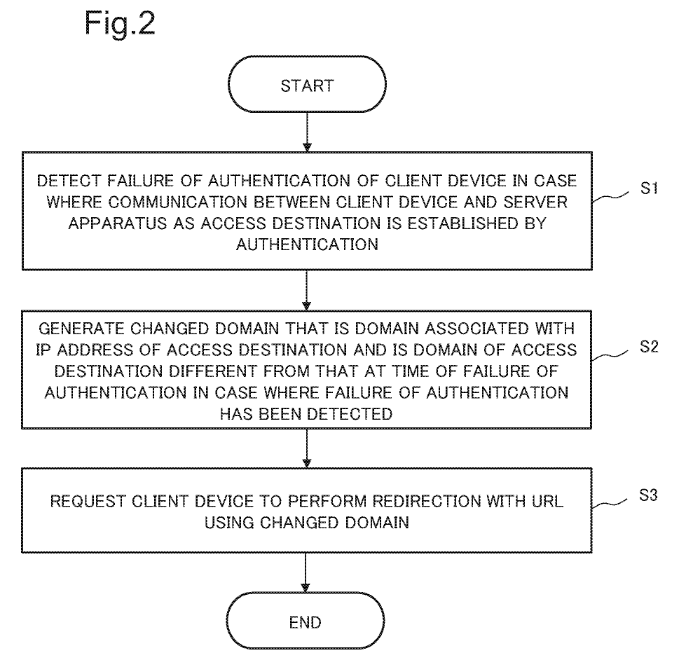

Next, an example of an operation of the information processing apparatus 100 will be described with reference to FIG. 2. In the present disclosure, each step of the flowchart is represented by using a number given to each step, such as “S1”.

FIG. 2 is a first flowchart illustrating the example of the operation of the information processing apparatus 100.

In a case where communication between the client device and the server apparatus as the access destination is established by authentication, the detection unit 110 detects failure of authentication of the client device (S1).

In a case where the failure of the authentication has been detected, the generation unit 120 generates the changed domain that is a domain associated with the IP address of the access destination and is a domain of the access destination different from that at the time of the failure of the authentication (S2).

The control unit 130 requests the client device to perform redirection with the URL using the changed domain (S3).

As described above, in a case where communication between the client device and the server apparatus as the access destination is established by authentication, the information processing apparatus 100 in the first example embodiment detects the failure of the authentication of the client device. In a case where the failure of the authentication has been detected, the information processing apparatus 100 generates the changed domain that is a domain associated with the IP address of the access destination and is a domain of the access destination different from that at the time of the failure of the authentication. The information processing apparatus 100 requests the client device to perform redirection with the URL using the changed domain.

The domain as the access destination and information indicating the failure are cached in a browser in the client device for which the authentication has failed. Therefore, in a case where authentication processing of the client device has been attempted again from the client device by using the same browser with the same URL as that at the time of the failure of the authentication, even if a correct certificate is selected, the failure state of the authentication of the client device is maintained. On the other hand, with the above-described configuration, even in a case where the authentication of the client device has failed, the information processing apparatus 100 can cause the server apparatus to perform the authentication processing of the client device again from the client device without restarting the browser. This is because the information processing apparatus 100 can cause access to the server apparatus again with a URL different from that at the time of the failure of the authentication. As described above, the information processing apparatus 100 can improve the convenience of the authentication processing when communication between the client device and the server apparatus is established.

### Second Example Embodiment

Next, an information processing apparatus according to a second example embodiment will be described. In the second example embodiment, another example related to the information processing apparatus described in the first example embodiment will be further described. A part of the description of content overlapping with that of the first example embodiment will be omitted.

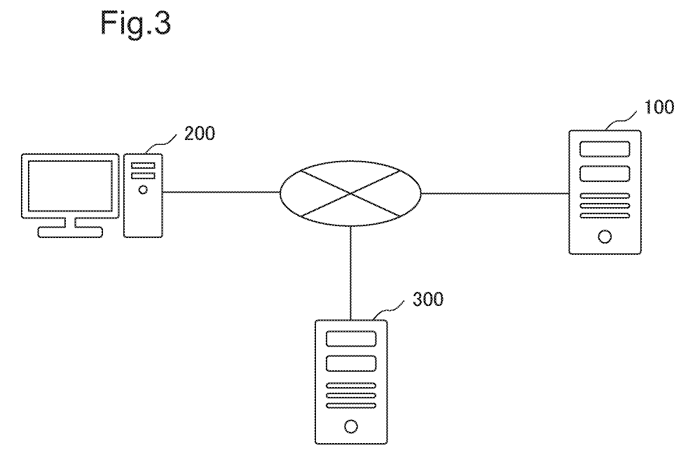

FIG. 3 is a first diagram schematically illustrating an example of a configuration including an information processing apparatus 100. As illustrated in FIG. 3, the information processing apparatus 100, a client device 200, and a domain name system (DNS) server 300 can communicate with each other via a wireless or wired network.

In the present example embodiment, an example of processing in a case where the information processing apparatus 100 has failed in authentication of the client device 200 in a situation where an attempt is made to establish communication between the client device 200 and the information processing apparatus 100 will be described. That is, an access destination is the information processing apparatus 100. In the present example embodiment, an example of a case where communication between the client device 200 and the information processing apparatus 100 is established by mTLS will be described.

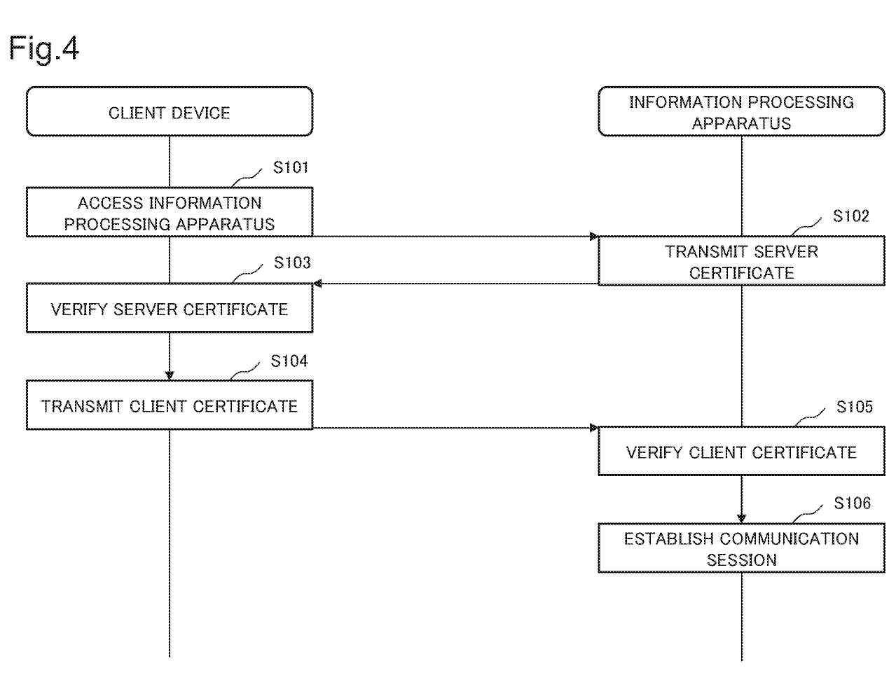

A situation in which communication between the client device 200 and the information processing apparatus 100 is established by mTLS in the present example embodiment will be described. FIG. 4 is a sequence diagram illustrating an example of establishment of communication by mTLS. First, the client device 200 accesses a server apparatus with which communication is desired. In this example, the client device 200 accesses the information processing apparatus 100 (S101). The access is relevant to a request for establishment of communication. The information processing apparatus 100 transmits a server certificate to the client device 200 (S102). The client device 200 verifies the server certificate (S103). In a case where the client device 200 has succeeded in the verification, that is, in a case where the client device 200 has successfully authenticated the information processing apparatus 100, the client device 200 transmits a client certificate to the information processing apparatus 100 (S104). The information processing apparatus 100 verifies the client certificate (S105). In a case where the information processing apparatus 100 has succeeded in the verification, that is, in a case where the information processing apparatus 100 has successfully authenticated the client device 200, the information processing apparatus 100 establishes a secure communication session with the client device 200 (S106). That is, encrypted communication can be made between the client device 200 and the information processing apparatus 100.

In the process of S105 in FIG. 4, in a case where the information processing apparatus 100 has failed to verify the client certificate, that is, in a case where the authentication of the client device 200 has failed, communication is not established. In this case, a domain as the access destination and information indicating the failure are cached in a browser of the client device 200. Therefore, for example, in a case where establishment of communication is requested again from the same browser, even if a certificate is appropriately selected, the failure state of authentication of the client device 200 is maintained. In the information processing apparatus 100 in the present example embodiment, in such processing, in a case where the authentication of the client device 200 has failed, the information processing apparatus 100 causes the authentication processing of the client device 200 to be performed again.

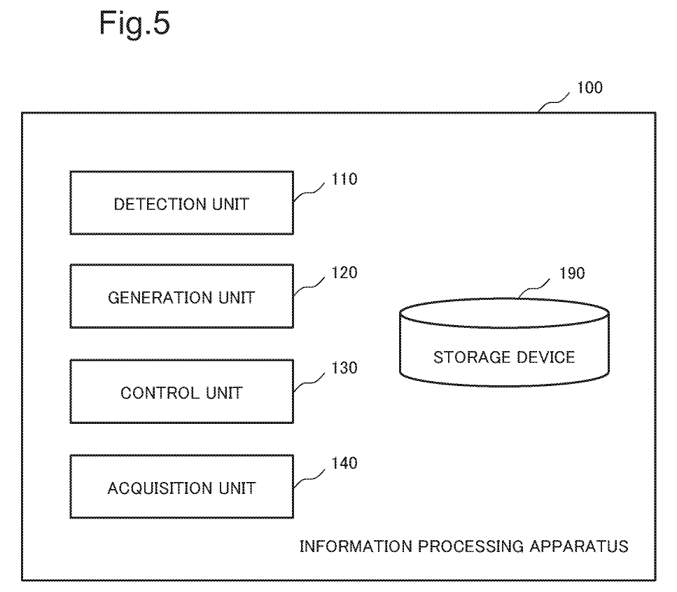

FIG. 5 is a second block diagram illustrating an example of a functional configuration of the information processing apparatus 100. The information processing apparatus 100 includes a detection unit 110, a generation unit 120, a control unit 130, and an acquisition unit 140. The acquisition unit 140 is an example of acquisition means. The information processing apparatus 100 further includes a storage device 190. The storage device 190 is an example of storage means. A plurality of storage devices 190 may be provided. The storage device 190 may be an external device capable of communicating with the information processing apparatus 100. The storage device 190 may exist both inside and outside the information processing apparatus 100.

The detection unit 110 detects failure of authentication of the client device 200. For example, in the process of S105, the detection unit 110 detects failure of authentication of the client device 200 based on the fact that the information processing apparatus 100 has failed in the verification of the client certificate.

The generation unit 120 generates a changed domain in a case where the failure of authentication has been detected. Specifically, in a case where the detection unit 110 has detected the failure of the authentication, the generation unit 120 generates a domain different from a domain used for the access. For example, the generation unit 120 generates a domain different from the domain used in the process of S101. Here, in the process of S101, the domain used for access may be referred to as a normal-time domain. That is, the normal-time domain is a domain that is normally used when the client device 200 accesses a desired server apparatus.

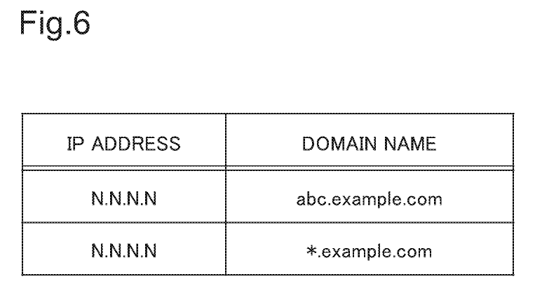

The changed domain generated by the generation unit 120 is associated with the same IP address as an IP address associated with the normal-time domain. A DNS record in which a domain name and an IP address are associated with each other is managed in the DNS server. FIG. 6 is a diagram illustrating an example of a DNS record. In the example of FIG. 6, an IP address “N.N.N.N” and a domain name “abc.example.com” are associated with each other. The IP address “N.N.N.N” and a domain name “*.example.com” are associated with each other. The IP address “N.N.N.N” indicates an IP address of an access destination of the client device 200. In this example, “abc.example.com” indicates the normal-time domain. That is, the normal-time domain and a domain different from the normal-time domain are associated with the same IP address.

Here, “*.example.com” indicates “*” as a subdomain in a fully qualified domain name (FQDN). “*” indicates a wildcard. That is, in this case, by using a URL including a domain in which any character string is inserted in a part of a wildcard, an access to a location whose IP address is “N.N.N.N” is possible. For example, the generation unit 120 may instruct the DNS server in advance to associate a domain using such a wildcard with the IP address “N.N.N.N”. That is, the generation unit 120 may associate a domain in which a subdomain is used as the wildcard in the normal-time domain of the access destination with the IP address of the access destination in advance.

The generation unit 120 may generate a domain in which the subdomain has been changed among the normal-time domains, as the changed domain. In the case of the example in FIG. 6, the generation unit 120 generates a changed domain in which the part of “abc” in “abc.example.com” has been changed to another character string. At this time, the generation unit 120 may randomly generate a character string of the subdomain part. A method of generating the character string of the subdomain part is not limited to this example.

Further, the generation unit 120 may generate a domain different from the already used domain, as the changed domain after the client device 200 has first made an access. For example, in the process of S101, it is assumed that the client device 200 performs access with the URL using “abc.example.com”, and the information processing apparatus 100 has failed in authentication of the client device 200. When “def.example.com” has been generated as the changed domain, the client device 200 performs access again with a URL using the changed domain. In such a case, when the information processing apparatus 100 has failed in authentication of the client device 200 again, the generation unit 120 generates a changed domain different from “abc.example.com” and “def.example.com”. As described above, the generation unit 120 may generate a domain different from the domain used by the client device 200 for access in the past, as the changed domain.

In this case, the acquisition unit 140 may acquire identification information of the client device 200 and the domain used for access by the client device 200. The identification information and the domain which have been acquired may be stored in the storage device 190 in association with each other. The generation unit 120 may generate a domain different from the domain used for access by the client device 200 in the past, as the changed domain, by using the information stored in the storage device 190.

The acquisition unit 140 may acquire the identification information of the client device 200, the domain used for access by the client device 200, and the date and time of the access. The identification information, the domain, and the access date and time, which have been acquired, may be stored in the storage device 190 in association with each other. The generation unit 120 may generate, as the changed domain, a domain different from the domain used for access by the client device 200 during a predetermined period, by using the information stored in the storage device 190.

The control unit 130 requests the client device 200 to perform redirection with the URL using the generated changed domain. For example, the control unit 130 causes access to the client device 200 with the URL using the changed domain. At this time, the control unit 130 may cause the client device 200 to display predetermined output information.

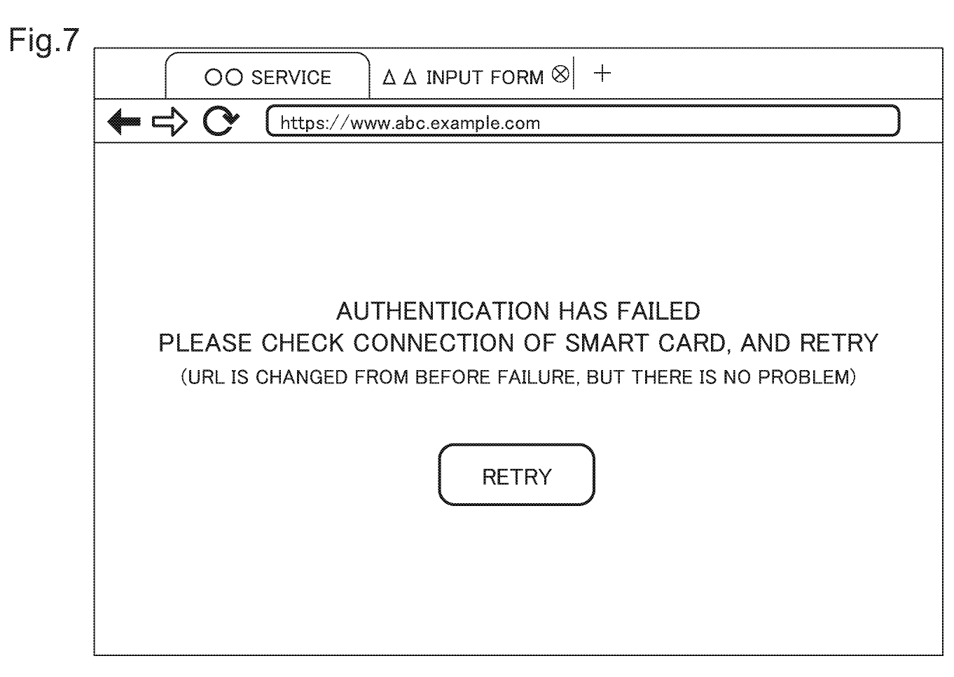

FIG. 7 is a first diagram illustrating an example of output information. Specifically, FIG. 7 is an example of output information displayed on a display of the client device 200 after the authentication has failed. In this example, there is a button labeled “Retry”. For example, when this button has been selected by a user, the control unit 130 may cause access to the client device 200 with the URL using the changed domain. In this example, a character string indicating that “authentication has failed” is indicated as information indicating that the information processing apparatus 100 has failed in authentication. A character string indicating that “please check connection of smart card and try again” is indicated as information indicating handling of the user. As information indicating that the URL indicating the access destination for which authentication has failed is different from the URL at the time of redirection, a character string indicating that “before failure, URL is changed, but there is no problem” is indicated. Various types of information illustrated in FIG. 7 are examples of information for prompting redirection.

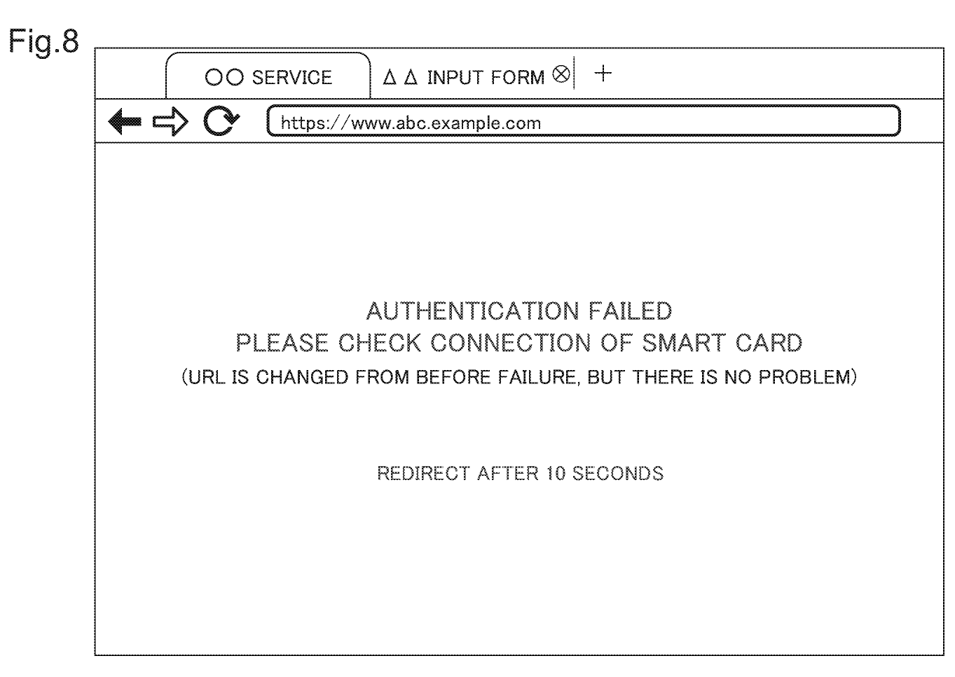

FIG. 8 is a second diagram illustrating an example of the output information. Specifically, FIG. 8 is an example of the output information displayed on the display of the client device 200 after the authentication has failed. In this example, a character string indicating that “redirect after 10 seconds” is displayed. That is, even though there is no operation by the user after 10 seconds, the control unit 130 causes access to the client device 200 with the URL using the changed domain. That is, FIG. 8 illustrates an example in which the control unit 130 performs redirection to the client device 200 after a predetermined time has elapsed after the authentication has failed. Various types of information illustrated in FIG. 8 are examples of information for prompting redirection.

The output information is not limited to the above-described examples. Various examples can be considered for the displayed text, an operation method of the user, and the like.

### Operation Example of Information Processing Apparatus 100

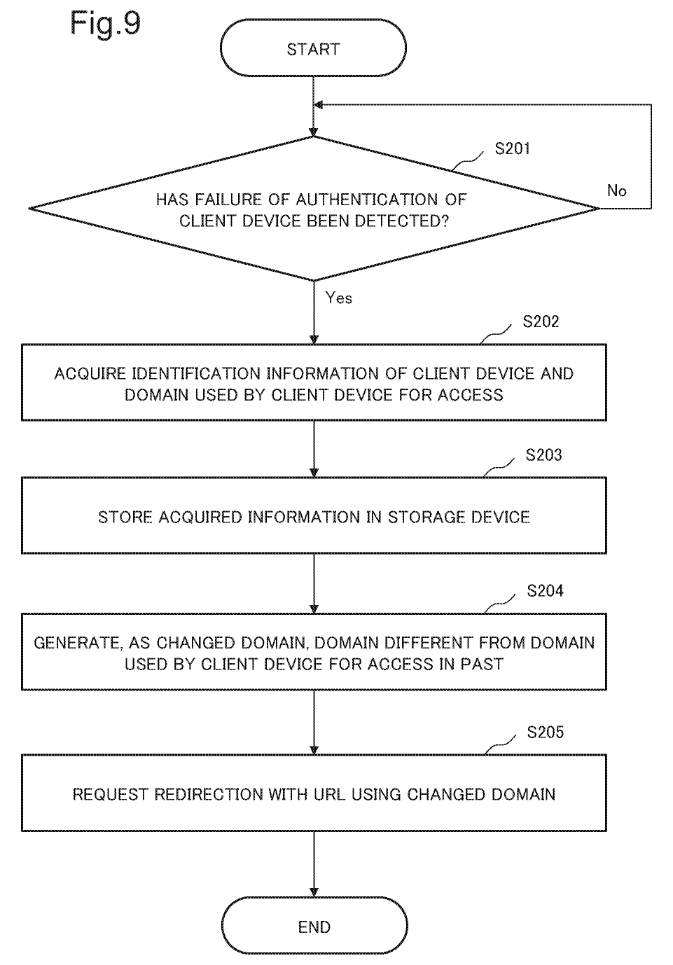

Next, an example of an operation of the information processing apparatus 100 will be described with reference to FIG. 9. FIG. 9 is a second flowchart illustrating the example of the operation of the information processing apparatus 100. More specifically, FIG. 9 is a diagram illustrating an example of an operation of the information processing apparatus 100 in a case where the information processing apparatus 100 has failed in authentication of the client device 200.

The detection unit 110 detects failure in authentication of the client device 200 (“Yes” in S201). In a case where the detection unit 110 does not detect the failure of the authentication of the client device 200, the information processing apparatus 100 does not perform the processing in and after S202.

When the failure of the authentication of the client device 200 is detected, the acquisition unit 140 acquires the identification information of the client device 200 and the domain used for the access by the client device 200 (S202). The acquisition unit 140 associates the acquired information and stores the resultant of the association in the storage device 190 (S203).

The generation unit 120 generates a changed domain (S204). Specifically, the generation unit 120 generates a domain different from the domain used by the client device for access in the past, as the changed domain.

The control unit 130 requests the client device 200 to perform redirection with the URL using the changed domain (S205).

This operation example is merely an example. The operation example of the information processing apparatus 100 according to the present disclosure is not limited to this example. For example, the processes of S202 and S203 may be performed before the process of S201, or may be performed simultaneously with the process of S201.

As described above, in a case where communication between the client device 200 and the server apparatus as the access destination is established by authentication, the information processing apparatus 100 in the second example embodiment detects the failure of the authentication of the client device 200. In a case where the failure of the authentication has been detected, the information processing apparatus 100 generates the changed domain that is a domain associated with the IP address of the access destination and is a domain of the access destination different from that at the time of the failure of the authentication. The information processing apparatus 100 requests the client device 200 to perform redirection with the URL using the changed domain.

The domain as the access destination and information indicating the failure are cached in a browser in the client device 200 for which the authentication has failed. Therefore, in a case where authentication processing of the client device 200 has been attempted again from the client device 200 by using the same browser with the same URL as that at the time of the failure of the authentication, even if a correct certificate is selected, the failure state of the authentication of the client device 200 is maintained. On the other hand, with the above-described configuration, the information processing apparatus 100 can cause the authentication processing of the client device 200 to be performed again without restarting the browser. This is because the information processing apparatus 100 can cause the client device 200 to perform access again with a URL different from that at the time of the failure of the authentication. As described above, the information processing apparatus 100 can improve the convenience of the authentication processing when communication between the client device and the server apparatus is established.

The information processing apparatus 100 may cause the client device 200 to output information for prompting redirection after authentication has failed. As a result, the information processing apparatus 100 can prompt the user of the client device 200 to perform a redirection operation or notify that redirection is to be performed.

The information processing apparatus 100 may cause the client device 200 to output information indicating that the URL indicating the access destination for which authentication has failed is different from the URL at the time of redirection. As described above, the URL at the time of redirection is different from the URL before redirection. Therefore, at the time of redirection, the user of the client device 200 may have anxiety that a wrong operation may have been performed or anxiety that a page has transitioned to an unintended web page. On the other hand, since the information processing apparatus 100 can notify the user that the URL at the time of redirection is different, it is possible to support removal of such anxiety.

The information processing apparatus 100 may generate, as the changed domain, a domain different from the domain used by the client device 200 to access the access destination during a predetermined period. As a result, even in a case where the information processing apparatus 100 has failed in authentication a plurality of times during a predetermined period, and the information and the domain used in the failure are cached in the browser on the client device 200 side, the information processing apparatus 100 can cause the client device 200 to perform access again with a URL different from that at the time of the failure of the authentication.

The information processing apparatus 100 may associate a domain in which a subdomain is used as the wildcard in the normal-time domain of the access destination with the IP address of the access destination. In a case where the failure of the authentication has been detected, the information processing apparatus 100 may generate a domain in which the subdomain has been changed among the normal-time domains of the access destination, as the changed domain. As a result, the information processing apparatus 100 can generate the changed domain without setting the DNS record every time the changed domain is generated.

### First Modification Example

The information processing apparatus 100 may update a DNS record every time a changed domain is generated.

Specifically, in a case where the failure of the authentication has been detected, the generation unit 120 updates the DNS record by associating the domain in which the subdomain has been changed among the normal-time domains, with the IP address of the access destination. In the example of FIG. 6, the normal-time domain “abc.example.com” and the IP address “N.N.N.N” are associated with each other. At this time, for example, the generation unit 120 updates the DNS record by associating “def.example.com” that is the changed domain with the IP address “N.N.N.N”. In this manner, the generation unit 120 may generate the changed domain.

After the DNS record has been updated, the control unit 130 requests the client device 200 to perform redirection with the URL using the generated changed domain.

As described above, in a case where the failure of the authentication has been detected, the information processing apparatus 100 may associate a domain that is different from the domain at the time of the failure of the authentication and in which the subdomain has been changed in the normal-time domain of the access destination, with the IP address of the access destination. The information processing apparatus 100 may generate a domain in which the subdomain has been changed, as the changed domain.

### Second Modification Example

The information processing apparatus 100 does not necessarily need to request redirection at the time of the failure of the authentication.

For example, in a case where authentication has failed a plurality of times, a malicious user may request establishment of communication. For such a case, the number of redirections may be limited.

Specifically, the acquisition unit 140 acquires the identification information of the client device 200 for which authentication has failed. The acquisition unit 140 registers the identification information of the client device 200 for which authentication has failed, in the storage device 190. That is, the storage device 190 stores the identification information and the number of authentication failures in association with each other.

By using the information stored in the storage device 190, the control unit 130 determines whether the number of failures of the client device 200 for which authentication has failed is equal to or more than a predetermined number of times. In a case where the number of failures is less than the predetermined number of times, the control unit 130 requests redirection from the client device 200. In a case where the number of failures is equal to or more than the predetermined number of times, the control unit 130 does not request redirection from the client device 200.

As described above, the information processing apparatus 100 may acquire the identification information of the client device 200 for which authentication has failed, and store the identification information and the number of authentication failures in association with each other. The information processing apparatus 100 may perform control so as not to request redirection from the client device 200 for which the number of authentication failures is equal to or more than the predetermined number of times.

### Third Modification Example

The information processing apparatus 100 may generate a domain in which the subdomain has been changed among the normal-time domains, as the changed domain. At this time, the information processing apparatus 100 may generate a character string of a subdomain part based on information associated with the client device 200.

Specifically, the generation unit 120 may set the character string of the subdomain part as a character string including information regarding the user such as the ID and the name of the user. For example, in the process of S101 in FIG. 4, it is assumed that login information such as a user ID is input by the user at the time of access. The generation unit 120 may use at least a part of the login information for the character string of the subdomain part. For example, it is assumed that the user ID is “userA”. At this time, the generation unit 120 may generate a changed domain of “userA.example.com”. Such information regarding the user is an example of the information associated with the client device 200.

The generation unit 120 may set the character string of the subdomain part as a character string including information regarding the device characteristics of the client device 200. For example, the generation unit 120 may generate a changed domain in which a character string including at least a part of the identification information of the client device 200 is set as the character string of the subdomain part. For example, the generation unit 120 may generate a changed domain in which a character string including at least a part of the date and time when the client device 200 has performed access and information associated with a network of the client device 200 is set as the character string of the subdomain part. Such information regarding the device characteristics of the client device 200 is an example of the information associated with the client device 200.

As described above, the information processing apparatus 100 may change the name of the subdomain in the normal-time domain of the access destination to a name based on the information associated with the client device 200.

### Fourth Modification Example

In the above-described examples, the information processing apparatus 100 is configured as illustrated in FIG. 3. However, the example in which the information processing apparatus 100 is configured is not limited to these examples.

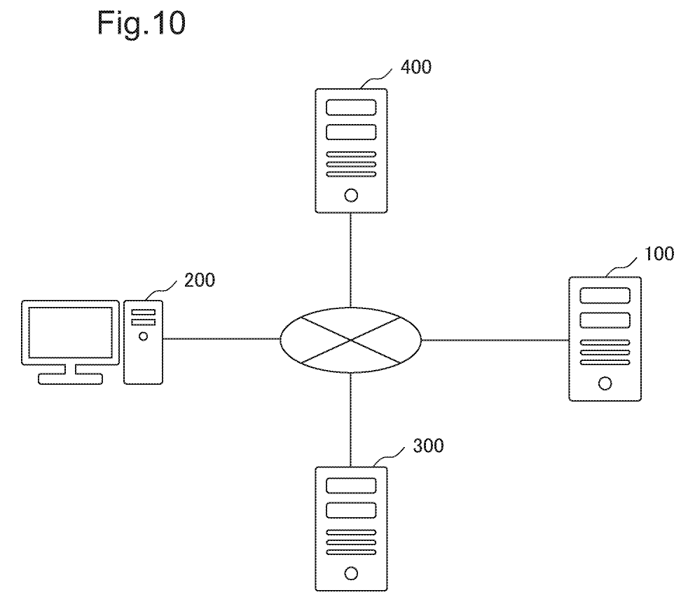

For example, authentication of the client device 200 may be performed by a server apparatus different from the information processing apparatus 100. FIG. 10 is a second diagram schematically illustrating an example of a configuration including the information processing apparatus 100. In the example of FIG. 10, the information processing apparatus 100 is further communicably connected to an authentication server 400. The authentication server 400 is also communicably connected to the client device 200. An example of the authentication server 400 is an identity provider (IdP) server.

In this example, in the process of S104, the client device 200 transmits a client certificate to the authentication server 400. In the process of S105, the authentication server 400 performs a process of authentication of the client device 200. In a case where the authentication server 400 has failed in the authentication of the client device 200, the authentication server 400 notifies the information processing apparatus 100 that the authentication of the client device 200 has failed. The detection unit 110 may detect the failure of the authentication of the client device 200 by receiving the notification from the authentication server 400.

Alternatively, the access destination of the client device 200 may be a server apparatus different from the information processing apparatus 100. In this case, in the process of S101, the client device 200 accesses the server apparatus. In the process of S102, the server apparatus transmits the server certificate to the client device 200. In the process of S103, the client device 200 verifies the server certificate. In the process of S104, the client device 200 transmits the client certificate to the server apparatus. In the process of S105, in a case where the authentication server 400 has failed in the authentication of the client device 200, this server apparatus notifies the information processing apparatus 100 that the authentication of the client device 200 has failed. The detection unit 110 may detect the failure of the authentication of the client device 200 by receiving the notification from this server apparatus.

In a case where a correct certificate is not selected, the client device or the server apparatus fails in authentication. In the case of authentication using a smart card having a certificate, in some cases, it is not possible to appropriately select a certificate due to a connection failure between the smart card and a client-side terminal, or the like. Even in such a case, the server apparatus fails in authentication.

In particular, when the server apparatus fails in authentication of the client device, a domain as an access destination and information indicating the failure may be cached in a browser on the client-device side. In this case, in a case where the client device requests authentication processing of the client device again, there is a possibility that the authentication of the client device fails even though a correct certificate is selected. This is because the browser refers to a cache and determines that the access has failed. That is, a failure state is maintained regardless of the selection of the certificate.

In such a case, it is conceivable to clear the cache by restarting the browser or the like. However, in this case, information input to the browser, information of other tabs in the browser, and the like are cleared together.

The present disclosure has been made in view of the above problems, and an object of the present disclosure is to provide an information processing apparatus and the like that improve convenience of authentication processing when communication between a client device and a server apparatus is established.

According to the present disclosure, it is possible to improve convenience of authentication processing when communication between a client device and a server apparatus is established.

### Configuration Example of Hardware of Information Processing Apparatus

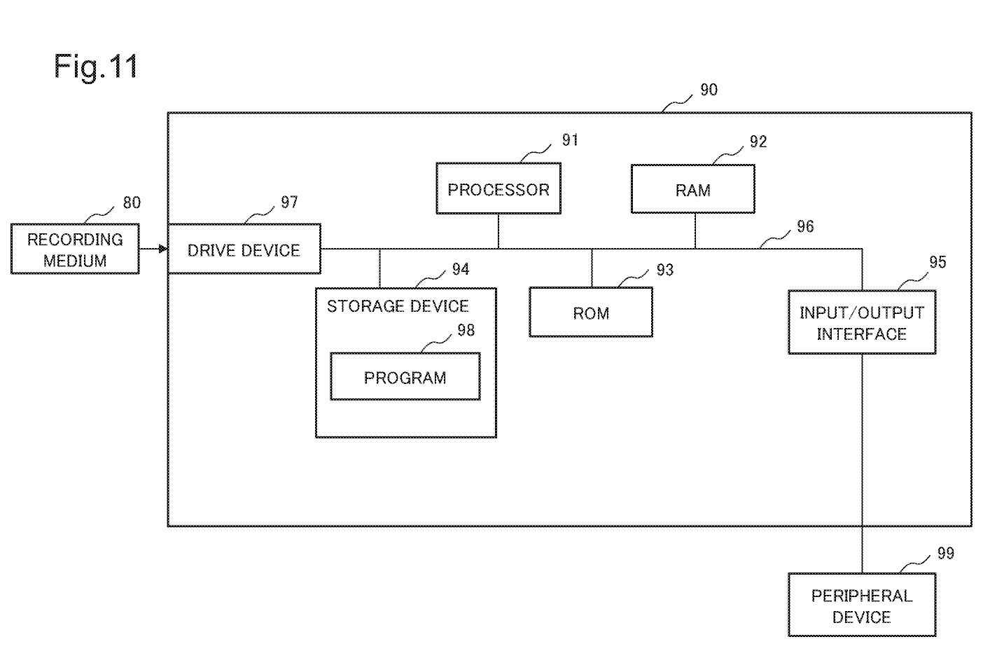

Hardware constituting the information processing apparatus in the first and second example embodiments described above will be described. FIG. 11 is a block diagram illustrating an example of a hardware configuration of a computer apparatus configuring the information processing apparatus in the example embodiments. In a computer apparatus 90, the information processing apparatus and the information processing method described in the example embodiments and the modification examples are implemented. For example, the information processing apparatus and the like described in the example embodiments and the modification examples may have a hardware configuration illustrated in FIG. 11.

As illustrated in FIG. 11, the computer apparatus 90 includes a processor 91, a random access memory (RAM) 92, a read only memory (ROM) 93, a storage device 94, an input/output interface 95, a bus 96, and a drive device 97. The information processing apparatus and the like may be implemented by a plurality of electric circuits.

The storage device 94 stores a program (computer program) 98. The processor 91 executes the program 98 of the information processing apparatus using the RAM 92. Specifically, for example, the program 98 includes a program that causes a computer to execute the processing illustrated in FIGS. 2 and 9 and the like. When the processor 91 executes the program 98, the function of each configuration of the information processing apparatus is implemented. The program 98 may be stored in the ROM 93. The program 98 may be recorded in a recording medium 80 and read by the drive device 97, or may be transmitted from an external device (not illustrated) to the computer apparatus 90 via a network (not illustrated).

The input/output interface 95 exchanges data with a peripheral device (such as a keyboard, a mouse, or a display device) 99. The input/output interface 95 functions as means for acquiring or outputting data. The bus 96 connects the components with each other.

There are various modification examples of the method of implementing the information processing apparatus. For example, each of the components included in the information processing apparatus can be implemented as a dedicated device. The information processing apparatus can be implemented based on a combination of a plurality of devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the present invention has been particularly shown and described with reference to example embodiments thereof, the present invention is not limited to these example embodiments. It will be understood by those of ordinary skill in the art that various changes in form and details may be made therein without departing from the spirit and scope of the invention of the present application as defined by the claims.

The above-described example embodiments and modification examples can be appropriately combined with each other.

### Supplementary Notes

Some or all of the above example embodiments may be described as the following Supplementary Notes, but are not limited to the following.

### Supplementary Note 1

An information processing apparatus including:
detection means for detecting a failure of authentication of a client device in a case where communication between the client device and a server apparatus as an access destination is established by authentication;
generation means for generating, in a case where the failure of authentication has been detected, a changed domain that is a domain associated with an IP address of the access destination and is a domain of the access destination different from a domain at time of the failure of authentication; and control control means for requesting the client device to perform redirection by a URL using the changed domain.

### Supplementary Note 2

The information processing apparatus according to Supplementary Note 1, in which
the control means causes the client device to output information for prompting redirection after the failure of the authentication.

### Supplementary Note 3

The information processing apparatus according to Supplementary Note 2, in which
the control means causes the client device to output information indicating that a URL indicating the access destination for which the authentication has failed is different from a URL at time of redirection.

### Supplementary Note 4

The information processing apparatus according to Supplementary Note 1, further including:
acquisition means for acquiring identification information of a client device that has failed in authentication; and
storage means for storing the identification information and the number of authentication failures in association with each other, in which
the control means does not request the redirection to a client device of which the number of authentication failures is equal to or more than a predetermined number of times.

### Supplementary Note 5

The information processing apparatus according to any one of Supplementary Notes 1 to 4, in which
the generation means generates, as the changed domain, a domain different from a domain used by the client device to access the access destination during a predetermined period.

### Supplementary Note 6

The information processing apparatus according to Supplementary Note 1, in which
the generation means associates a domain in which a subdomain is used as a wildcard among normal-time domains of the access destination with an IP address of the access destination, and
in a case where the failure of authentication has been detected, the generation means generates a domain in which a subdomain has been changed among the normal-time domains of the access destination, as the changed domain.

### Supplementary Note 7

The information processing apparatus according to Supplementary Note 1, in which
in a case where the failure of the authentication has been detected, the generation means associates a domain that is different from the domain at the time of the failure of authentication and in which a subdomain has been changed among normal-time domains of the access destination, with an IP address of the access destination, and
the generation means generates a domain in which the subdomain has been changed, as the changed domain.

### Supplementary Note 8

The information processing apparatus according to Supplementary Note 6 or 7, in which
the generation means changes a name of the subdomain among normal-time domains of the access destination to a name based on information associated with the client device.

### Supplementary Note 9

An information processing method including:
detecting a failure of authentication of a client device in a case where communication between the client device and a server apparatus as an access destination is established by authentication;
generating, in a case where the failure of authentication has been detected, a changed domain that is a domain associated with an IP address of the access destination and is a domain of the access destination different from a domain at time of the failure of authentication; and
requesting the client device to perform redirection by a URL using the changed domain.

### Supplementary Note 10

A program for causing a computer to execute a process including:
detecting a failure of authentication of a client device in a case where communication between the client device and a server apparatus as an access destination is established by authentication;
generating, in a case where the failure of authentication has been detected, a changed domain that is a domain associated with an IP address of the access destination and is a domain of the access destination different from a domain at time of the failure of authentication; and
requesting the client device to perform redirection by a URL using the changed domain.
Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as a Supplementary Note can be similarly dependent on various types of hardware and software, various recording means for recording software, or various systems, without departing from the above-described example embodiments.

1. An information processing apparatus comprising:
at least one memory configured to store instructions; and
at least one processor configured to execute the instructions to:
detect a failure of authentication of a client device in a case where communication between the client device and a server apparatus as an access destination is established by authentication;
generate, in a case where the failure of authentication has been detected, a changed domain that is a domain associated with an IP address of the access destination and is a domain of the access destination different from a domain at time of the failure of authentication; and
request the client device to perform redirection by a URL using the changed domain.

2. The information processing apparatus according to claim 1, wherein the at least one processor is further configured to execute the instructions to:
cause the client device to output information for prompting redirection after the failure of the authentication.

3. The information processing apparatus according to claim 2, wherein the at least one processor is further configured to execute the instructions to:
cause the client device to output information indicating that a URL indicating the access destination for which the authentication has failed is different from a URL at time of redirection.

4. The information processing apparatus according to claim 1, wherein the at least one processor is further configured to execute the instructions to:
acquire identification information of a client device that has failed in authentication;
store the identification information and the number of authentication failures in association with each other; and
not request the redirection to a client device of which the number of authentication failures is equal to or more than a predetermined number of times.

5. The information processing apparatus according to claim 1, wherein the at least one processor is further configured to execute the instructions to:
generate, as the changed domain, a domain different from a domain used by the client device to access the access destination during a predetermined period.

6. The information processing apparatus according to claim 1, wherein the at least one processor is further configured to execute the instructions to:
associate a domain in which a subdomain is used as a wildcard among normal-time domains of the access destination with an IP address of the access destination, and
in a case where the failure of authentication has been detected, generate a domain in which a subdomain has been changed among the normal-time domains of the access destination, as the changed domain.

7. The information processing apparatus according to claim 1, wherein the at least one processor is further configured to execute the instructions to:
in a case where the failure of the authentication has been detected, associate a domain that is different from the domain at the time of the failure of authentication and in which a subdomain has been changed among normal-time domains of the access destination, with an IP address of the access destination, and
generate a domain in which the subdomain has been changed, as the changed domain.

8. The information processing apparatus according to claim 6, wherein the at least one processor is further configured to execute the instructions to:
change a name of the subdomain in the normal-time domain of the access destination to a name based on information associated with the client device.

9. An information processing method comprising:
detecting a failure of authentication of a client device in a case where communication between the client device and a server apparatus as an access destination is established by authentication;
generating, in a case where the failure of authentication has been detected, a changed domain that is a domain associated with an IP address of the access destination and is a domain of the access destination different from a domain at time of the failure of authentication; and
requesting the client device to perform redirection by a URL using the changed domain.

10. The information processing method according to claim 9, further comprising:
causing the client device to output information for prompting redirection after the failure of the authentication.

11. The information processing method according to claim 10, further comprising:
causing the client device to output information indicating that a URL indicating the access destination for which the authentication has failed is different from a URL at time of redirection.

12. The information processing method according to claim 9, further comprising:
acquiring identification information of a client device that has failed in authentication; and
storing the identification information and the number of authentication failures in association with each other, wherein
not requesting the redirection to a client device of which the number of authentication failures is equal to or more than a predetermined number of times.

13. The information processing method according to claim 9, further comprising:
generating, as the changed domain, a domain different from a domain used by the client device to access the access destination during a predetermined period.

14. The information processing method according to claim 9, further comprising:
associating a domain in which a subdomain is used as a wildcard among normal-time domains of the access destination with an IP address of the access destination, and
in a case where the failure of authentication has been detected, generating a domain in which a subdomain has been changed among the normal-time domains of the access destination, as the changed domain.

15. The information processing method according to claim 9, further comprising:
in a case where the failure of the authentication has been detected, associating a domain that is different from the domain at the time of the failure of authentication and in which a subdomain has been changed among normal-time domains of the access destination, with an IP address of the access destination, and
generating a domain in which the subdomain has been changed, as the changed domain.

16. The information processing method according to claim 14, further comprising:
changing a name of the subdomain in the normal-time domain of the access destination to a name based on information associated with the client device.

17. A non-transitory computer-readable recording medium storing a program for causing a computer to execute a process comprising:
detecting a failure of authentication of a client device in a case where communication between the client device and a server apparatus as an access destination is established by authentication;
generating, in a case where the failure of authentication has been detected, a changed domain that is a domain associated with an IP address of the access destination and is a domain of the access destination different from a domain at time of the failure of authentication; and
requesting the client device to perform redirection by a URL using the changed domain.

18. The non-transitory computer-readable recording medium according to claim 17, wherein the program further causes the computer to execute:
causing the client device to output information for prompting redirection after the failure of the authentication.

19. The non-transitory computer-readable recording medium according to claim 18, wherein the program further causes the computer to execute:
causing the client device to output information indicating that a URL indicating the access destination for which the authentication has failed is different from a URL at time of redirection.

20. The non-transitory computer-readable recording medium according to claim 17, wherein the program further causes the computer to execute:
acquiring identification information of a client device that has failed in authentication; and
storing the identification information and the number of authentication failures in association with each other, wherein
not requesting the redirection to a client device of which the number of authentication failures is equal to or more than a predetermined number of times.
